(19) United States
(12) Patent Application Publication
(10) Pub. No.: US 2015/0375628 A1
(43) Pub. Date: Dec. 31, 2015

(54) MULTI-DIRECTIONAL CONVERTER COMPRISING THREE PORTS AND A SINGLE TRANSFORMER FOR ELECTRIC VEHICLES

(71) Applicant: INTELLIGENT ELECTRONIC SYSTEMS, Montpellier (FR)

(72) Inventors: Eric BIAGINI, Perols (FR); François COSTE, Montpellier (FR)

(73) Assignee: INTELLIGENT ELECTRONIC SYSTEMS, Montpellier (FR)

(21) Appl. No.: 14/411,936

(22) PCT Filed: Jul. 19, 2013
(86) PCT No.: PCT/EP2013/065314

§ 371 Date: Dec. 30, 2014

(30) Foreign Application Priority Data
Jul. 20, 2012 (FR) 12/57035

(51) Int. Cl. B60L 11/18

(52) U.S. Cl. CPC B60L 11/1814; B60L 11/1816

(57) ABSTRACT

The invention relates to a charging device including a reversible AC/DC converter enabling power to be supplied to two outlets that have different voltages. Said charging device is particularly suitable for use as an on-board electric motor vehicle device. The device enables power to be supplied to both a traction battery, at a relatively high voltage, and apparatuses from the very low-voltage grid. Said device has a small overall size and low weight. The invention rests on a DC/DC converter (in the AC/DC converter) having multiple reversible outlets that includes a single transformer.

### FIELD OF THE INVENTION

The present invention relates to a charging device comprising a reversible AC/DC converter for supplying two outputs at different voltages. This charging device is particularly suitable for use as an onboard device in an electric motor vehicle.

### TECHNICAL BACKGROUND

Many mobile machines use electrical energy and are equipped with batteries, for example electric vehicles, platforms, pallet trucks, etc. These machines generally comprise onboard chargers, that is to say electric battery chargers that are mounted directly on the mobile machines. They may also be used with an external battery charging device.

The main function of these chargers is recharging the batteries from electricity available on the electrical distribution network. They therefore convert alternating current into direct current.

For reasons of range and efficiency, the traction battery or batteries (which are used for supplying the traction system, that is to say the drive, for the above machines) have high voltages (for example 48 V, 60 V or even 400 V and more), whereas the onboard electronics require a lower voltage. The most widespread nominal voltage is 12 V: it corresponds to the equipment traditionally used in the automobile environment.

It is therefore necessary to add a DC/DC voltage converter, which lowers the voltage of the traction battery to the value required by the onboard equipment.

It is advantageous to integrate both this DC/DC converter and the means for charging the traction battery in the same charging device, in order to make savings in volume, weight, connections and reliability, and to facilitate the integration of this equipment in the vehicle or other motorised machine.

However, it still remains desirable to reduce the overall size and the weight of the charging devices of this type.

### SUMMARY OF THE INVENTION

The invention firstly relates to a charging device for a motorised appliance, the motorised appliance comprising a battery and equipment, the charging device comprising a first conversion module and a second conversion module connected to the first conversion module, wherein:
the first conversion module is also adapted for being connected to an alternating current source;
the second conversion module is also adapted for being connected to the battery and for being connected to the equipment, and said second conversion module comprises a single transformer;

the charging device being adapted for:
being supplied by the alternating current source with input alternating current, converting, in the first conversion module, this input alternating current into direct current having a first voltage, and furthermore:
converting, in the second conversion module, the direct current having the first voltage into direct current having a second voltage, and supplying the battery with this direct current having the second voltage, and
converting, in the second conversion module, the direct current having the first voltage into direct current having a third voltage, and supplying the equipment with this direct current having the third voltage; and
being supplied by the battery with direct current having the second voltage, converting, in the second conversion module, this direct current having the second voltage into direct current having the third voltage, and supplying the equipment with this direct current having the third voltage.

Preferably, a secondary battery figures among the equipment, and the device is adapted for being supplied by the secondary battery with direct current having the third voltage, and converting, in the second conversion module, this direct current having the third voltage into direct current having the first voltage, in order to supply the first conversion module.

According to one embodiment, the charging device is also adapted for:
being supplied by the battery with direct current having the second voltage, and converting, in the second conversion module, this direct current having the second voltage into direct current having the first voltage, converting, in the first conversion module, this direct current having the first voltage into output alternating current, and supplying the alternating current source with this output alternating current.

According to one embodiment, the second conversion module comprises a first conversion circuit connected to the first conversion module, a second conversion circuit adapted for being connected to the battery, and a third conversion circuit adapted for being connected to the equipment, these three conversion circuits being connected to the single transformer, the charging device preferably comprising a unit for controlling the three conversion circuits.

According to one embodiment, the charging device is adapted for simultaneously supplying the battery with direct current having the second voltage and the equipment with direct current having the third voltage, the charging device preferably comprising means for regulating the third voltage independently of the second voltage.

According to one embodiment:
the input alternating current has a voltage of 80 V to 300 V, preferably from 85 V to 265 V and/or a power of 0.5 kW to 35 kW, preferably from 1 kW to 6 kW; and/or
the first voltage is equal to 270 V to 440 V, preferably from 290 V to 430 V; and/or
the second voltage is equal to 20 V to 550 V, preferably from 24 V to 500 V; and/or
the third voltage is equal to 5 V to 20 V, preferably from 10 V to 15 V, for example approximately 12 V.

According to one embodiment, the equipment comprises one or more items of equipment selected from a secondary battery, sensors, indicator lights, an onboard computer, lighting means and a car radio.

According to one embodiment, the motorised appliance is a vehicle, preferably an electrically supplied motor vehicle.

The invention also relates to a motorised appliance comprising the charging device as described above, the battery and the equipment, the equipment preferably being selected from a secondary battery, sensors, indicator lights, an onboard computer, lighting means and a car radio.

According to one embodiment, the motorised appliance is a vehicle, preferably an electrically supplied motor vehicle.

The invention also relates to a method for charging a battery and supplying equipment of a motorised appliance, comprising:
according to a first operating mode, providing an input alternating current, converting the input alternating current into direct current having a first voltage, and:
converting the direct current having the first voltage into direct current having a second voltage, and supplying the battery with the direct current having the second voltage; and/or
converting the direct current having the first voltage into direct current having the third voltage, and supplying the equipment with the direct current having the third voltage;
according to a second operating mode, providing direct current having the second voltage by the battery, converting the direct current having the second voltage into direct current having the third voltage, and supplying the equipment with the direct current having the third voltage;
the first operating mode and the second operating mode being implemented separately in time;
wherein each conversion of a direct current into another direct current having a different voltage comprises a step of transformation into an intermediate alternating current by means of the same single transformer.

Preferably, a secondary battery figures among the equipment, and the method comprises, according to a third operating mode, providing direct current having the third voltage by the secondary battery, converting the direct current having the third voltage into direct current having the first voltage, and converting the direct current having the first voltage into alternating current.

According to one embodiment, the charging method also comprises:
according to a fourth operating mode, providing direct current having the second voltage by the battery, converting the direct current having the second voltage into direct current having the first voltage, and converting the direct current having the first voltage into output alternating current, and providing the output alternating current to an external electrical network.

According to one embodiment, in the first operating mode, supplying the battery with direct current having the second voltage and supplying the equipment with direct current having the third voltage are at least partially simultaneous, the method preferably comprising regulating the third voltage independently of the second voltage.

According to one embodiment:
the input alternating current has a voltage of 80 V to 300 V, preferably from 85 V to 265 V, and/or a power of 0.5 kW to 35 kW, preferably from 1 kW to 6 kW; and/or
the first voltage is equal to 270 V to 440 V, preferably from 290 V to 430 V; and/or
the second voltage is equal to 20 V to 550 V, preferably from 24 V to 500 V; and/or
the third voltage is equal to 5 V to 20 V, preferably from 10 V to 15 V, for example approximately 12 V.

According to one embodiment, the equipment comprises one or more items of equipment chosen from a secondary battery, sensors, indicator lights, an onboard computer, lighting means and a car radio.

According to one embodiment, the motorised appliance is a vehicle, preferably an electrically supplied motor vehicle.

The present invention overcomes the drawbacks of the prior art. It provides more particularly a charging device for supplying both a traction battery at a relatively high voltage and equipment in the so-called “very low voltage” network, this charging device having a smaller overall size and weight than in the prior art.

The invention also simplifies the connections, provides a more reliable system and facilitates the integration of the charging device in the motorised appliance.

This is accomplished by means of the development of a DC/DC converter (referred to as the second conversion module in the context of the application) for supplying both the traction battery and the very low voltage equipment, said DC/DC converter being reversible, that is to say able to be supplied both by an external source and by the traction battery, and based on a single transformer.

Thus the use of at least two transformers is avoided, namely one for supplying the traction battery and one for supplying the very low voltage equipment, as is the case according to the prior art.

The single transformer offers galvanic isolation between the three types of direct current flowing in the system, which makes it possible to meet the normative requirements in respect of safety, in particular when the battery voltage is high and therefore must be isolated from the onboard equipment.

Because of the use of a single transformer, this transformer can transfer the same electrical power to the main battery and from the main battery. Thus, without increasing the weight and volume of the charging device, high power is available in running mode for the onboard equipment. This is all the more advantageous since the onboard equipment at the present time has a tendency to consume more and more electric power in running mode, with for example consumption peaks at 2 kW for electric car equipment.

### BRIEF DESCRIPTION OF THE FIGURES

FIG. 1 is a schematic view of a charging device according to the invention, integrated in a motorised appliance, functioning according to the first operating mode (charging mode).

FIG. 2 is a schematic view of a charging device according to the invention, integrated in a motorised appliance, functioning according to the second operating mode (running mode).

FIG. 3 is a schematic view of a charging device according to the invention, integrated in a motorised appliance, functioning according to the fourth operating mode (redistribution mode).

FIG. 4 is a schematic view of an embodiment of the second conversion module used in the scope of the invention.

FIG. 5 is a schematic view of a charging device according to the invention, integrated in a motorised appliance, functioning according to the third operating mode (redistribution mode).

### DESCRIPTION OF EMBODIMENTS OF THE INVENTION

The invention is now described in more detail and in a non-limiting manner in the following description.

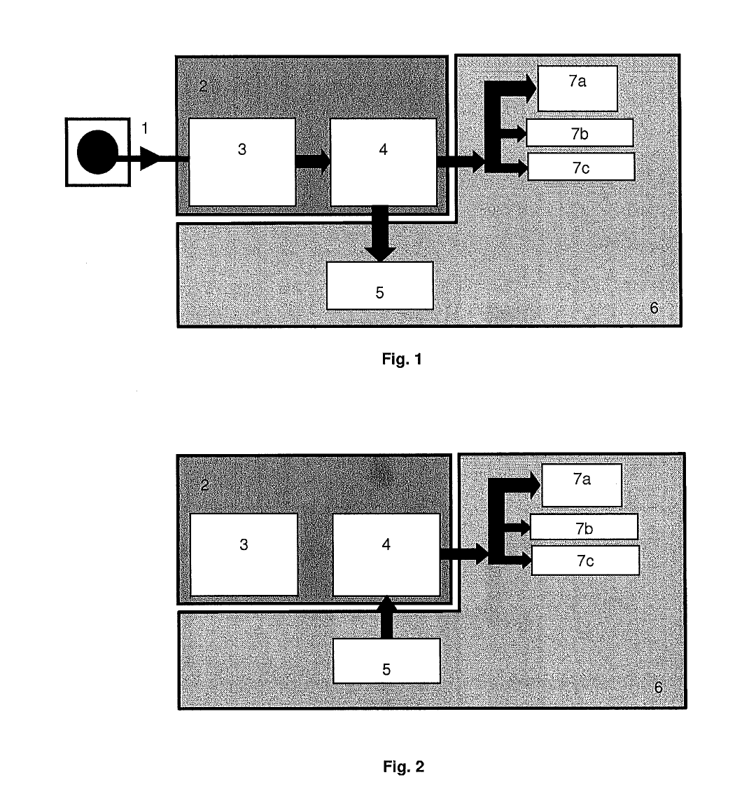

Referring to FIGS. 1, 2 and 3, a charging device 2 according to the invention is adapted for being mounted or integrated in a motorised appliance 6 that comprises a battery 5 and equipment 7a, 7b, 7c.

According to a preferred embodiment, the motorised appliance 6 is an electrically supplied vehicle, in particular an electrically supplied motor vehicle. In other embodiments, the motorised appliance 6 may be a handling machine such as an elevator platform, a lift truck or a pallet truck.

The battery 5 preferably represents the traction battery of the vehicle (or machine), that is to say the battery responsible for the supply to the motor of the vehicle (or machine). Naturally this battery 5 may represent a single battery or a set of batteries.

The equipment 7a, 7b, 7c may comprise sensors, indicator lights, an onboard computer, lighting means, a car radio, etc.

There may also comprise a secondary battery 7a, itself able to supply the rest of the equipment 7b, 7c.

The charging device 2 comprises a first conversion module 3 (AC/DC conversion module) and a second conversion module 4 (DC/DC conversion module) that is connected to the first conversion module 3 and is connected, when the charging device 2 is integrated in the motorised appliance 6, to the battery 5 and to the equipment 7a, 7b, 7c.

In the first operating mode, referred to as the charging mode and depicted in FIG. 1, a supply source 1 (such as the electrical network) is connected to the first conversion module 3 and supplies it with alternating current. This supply source 1 may be a single-phase, two-phase or three-phase source or any other electrical source.

The first conversion module 3 converts the input alternating current into direct current having the first voltage (denoted voltage V1) and supplies a second conversion module 4 with this current of voltage V1.

The second conversion module 4 converts the direct current having the voltage V1 into direct current having the second voltage (denoted voltage V2), which supplies the battery 5 (which is thus charged).

Optionally, the second conversion module 4 also converts the direct current having the voltage V1 into a direct current having the third voltage (denoted voltage V3), which supplies the equipment 7a, 7b, 7c.

In a second operating mode, referred to as the running mode and depicted in FIG. 2, the charging device is disconnected from any external supply source. In this operating mode, the battery 5 supplies direct current having the voltage V2 to the second conversion module 4, which converts this current into direct current having the voltage V3 supplying the equipment 7a, 7b, 7c.

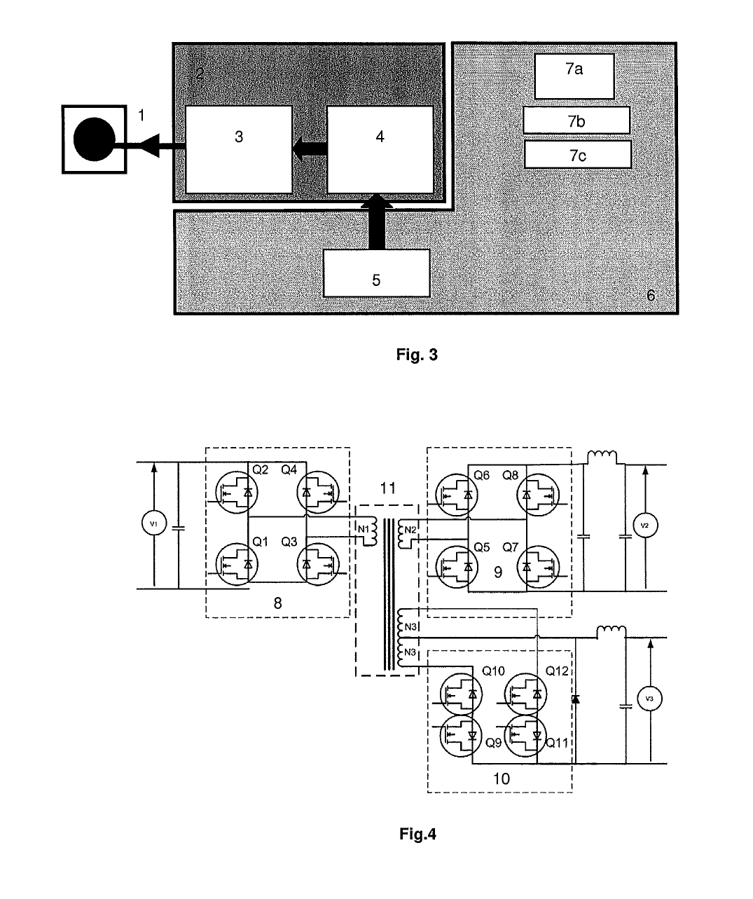

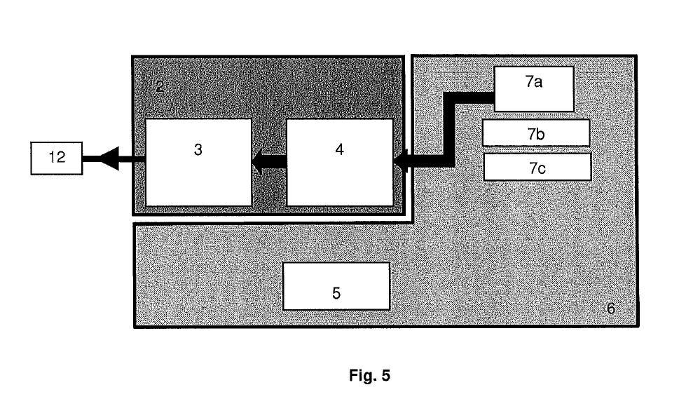

Two redistribution modes are also possible: the third operating mode, depicted in FIG. 5, and the fourth operating mode (optional) depicted in FIG. 3.

In the fourth operating mode, the battery 5 supplies direct current having the voltage V2 to the second conversion module 4, which converts this current into direct current having the voltage V1 supplying the first conversion module 3, and the first conversion module 3 converts this direct current having the voltage V1 into output alternating current, which is provided to the outside of the motorised appliance 6, that is to say for example which is redistributed to the electrical network, in the context of a so-called “intelligent” management of the electrical energy, making it possible in particular to respond to consumption peaks on the electrical network by having recourse to the batteries of the motorised appliances connected to said network.

It must also be emphasised that, in the context of this redistribution mode, there may also be a supplying of the equipment 7a, 7b, 7c with direct current having the voltage V3 by the second conversion module 4, just as in running mode.

Referring to FIG. 5, in the third operating mode, which assumes that the equipment 7a, 7b, 7c comprises a secondary battery 7a, said secondary battery supplies the second conversion module 4 with direct current having the voltage V3, for example for converting into direct current having the voltage V1 and supplying the first conversion module 3.

The alternating current thus produced at the output of the first conversion module 3 can be redistributed to the electrical network, just as in the fourth operating mode. Alternatively, and as illustrated in the figure, it may serve to supply the supplementary equipment 12 connected to the motorised appliance, preferably with a relatively low power, for example removable electronic equipment such as a laptop computer, a mobile telephone, a digital tablet or the like. Advantageously this supplementary equipment may be connected by means of conventional sockets, which are also adapted for connecting this supplementary equipment to the mains.

The input alternating current may be either single phase, for example with a voltage of 85 V to 265 V, or two-phase, for example with a voltage of 200 V to 250 V, or multi-phase and in particular three-phase, for example with a voltage of 380 V to 420 V.

The first conversion module 3 in general comprises a power factor correction circuit (PFC) in order to limit the input current harmonics. Such a circuit also has the advantage of functioning over a wide range of input voltages.

The voltage V1 of the direct current issuing from the first conversion module 3 and supplying the second conversion module 4 (or optionally vice versa) is in general 270 V to 440 V, preferably 290 V to 430 V. By way of example, this current may have a voltage of approximately 400 V.

The voltage V2 of the direct current issuing from the second conversion module 4 and supplying the battery 5 (or vice versa) is in general 20 V to 550 V, preferably 24 V to 500 V. According to one embodiment, the voltage V2 is equal or practically equal to the voltage V1. It may thus be approximately 400 V. According to another embodiment, the voltage V2 is less than the voltage V1. For example the voltage V2 may be approximately 60 V.

It should be noted that the value of the voltage V2 may vary over time: it is in principle the battery 5 (and its charging level) that imposes the value of the voltage V2.

The voltage V1 may also vary according to the voltage V2, for example by means of an adaptation of the operating conditions of the first conversion module 3 to the delivered voltage V2, according to the charge level of the battery.

The voltage V3 of the direct current issuing from the second conversion module 4 and supplying the equipment 7a, 7b, 7c (optionally or conversely) is generally less than the voltage V1 and less than the voltage V2.

It is typically from 5 V to 20 V, preferably 10 V to 15 V, for example approximately 12 V.

Referring to FIG. 4, an example of the second reversible conversion module 4 according to the invention is described.

Thus the second conversion module 4 comprises a first conversion circuit 8, a second conversion circuit 9 and a third conversion circuit 10.

These three conversion circuits 8, 9, 10 are connected to a single transformer 11, that is to say a transformer comprising a single magnetic element and at least three windings connected to each of the three conversion circuits 8, 9, 10.

The first conversion circuit 8 is connected to the first conversion module 3 by one of its ends opposite the one connected to the transformer 11. Thus this first conversion circuit 8 converts an input direct current having the voltage V1 into an intermediate alternating current supplying the transformer 11, or optionally vice versa.

The second conversion current 9 is connected to the battery 5 by one of its ends opposite the one connected to the transformer 11. Thus this second conversion circuit 9 converts an intermediate alternating current issuing from the transformer 11 into a direct current having the voltage V2 as an output supplying the battery 5 (in charging mode), or vice versa (in running or redistribution mode).

The third conversion circuit 10 is connected to the equipment 7a, 7b, 7c by one of its ends opposite the one connected to the transformer 11. Thus this third conversion circuit 10 converts an intermediate alternating current issuing from the transformer 11 into direct current having the voltage V3 as an output supplying the equipment 7a, 7b, 7c (in charging or running mode or optionally redistribution mode), or optionally vice versa (in some embodiments of the redistribution mode).

Thus, preferably, the first conversion circuit 8, the second conversion circuit 9 and the third conversion circuit 10 are reversible, that is to say they can function in “normal” mode or in “reverse” mode, the input of the circuit in normal mode corresponding to the output of the circuit in reverse mode, and the output of the circuit in normal mode corresponding to the input to the circuit in reverse mode.

The intermediate alternating currents mentioned above are alternating currents having a chopping frequency that is preferably relatively high.

Each conversion circuit 8, 9, 10 comprises for example a set of switching elements (denoted Q1, Q2, Q3, Q4; Q5, Q6, Q7, Q8; and Q9, Q10, Q11, Q12 in FIG. 4). These switching elements are activated synchronously either to chop a direct current into alternating current, or to rectify an alternating current into direct current, depending on the direction of use of the circuits.

Preferably, a centralised control unit provided with a digital programmer controls the three conversion circuits 8, 9, 10 in particular via the switching elements.

This control unit may in particular comprise means for regulating the voltage V3 independently (in a decorrelated manner) of the voltage V2. This is particularly advantageous in order to prevent the variations in the voltage V2 according to the charge level of the battery 5 having any influence on the electrical supply of the very low voltage network.

When one of the conversion circuits is not being used, for example the first conversion circuit 8 in running mode, it may be disconnected by a switching element (relay).

Each conversion circuit 8, 9, 10, and in particular the third conversion circuit 10, may comprise synchronous rectification means, making it possible to increase the efficiency by actively controlling the diodes and the MOSFET-type components synchronously.

1. Charging device (2) for a motorised appliance (6), the motorised appliance (6) comprising a battery (5) and equipment (7a, 7b, 7c) among which a secondary battery (7a), the charging device comprising a first conversion module (3) and a second conversion module (4) connected to the first conversion module (3), wherein:
the first conversion module (3) is also adapted for being connected to an alternating current source (1);
the second conversion module (4) is also adapted for being connected to the battery (5), and for being connected to the equipment (7a, 7b, 7c), and said second conversion module (4) comprises a single transformer (11);
the charging device (2) being adapted for:
being supplied by the alternating current source (1) with input alternating current, converting, in the first conversion module (3), this input alternating current into direct current having a first voltage, and furthermore:
converting, in the second conversion module (4), the direct current having the first voltage into direct current having a second voltage, and supplying the battery (5) with this direct current having the second voltage, and
converting, in the second conversion module (4), the direct current having the first voltage into direct current having a third voltage, and supplying the equipment (7a, 7b, 7c) with this direct current having the third voltage; and
being supplied by the battery (5) with direct current having the second voltage, converting, in the second conversion module (4), this direct current having the second voltage into direct current having the third voltage, and supplying the equipment (7a, 7b, 7c) with this direct current having the third voltage; and
being supplied by the secondary battery (7a) with direct current having the third voltage, and converting, in the second conversion module (4), this direct current having the third voltage into direct current having the first voltage, in order to supply the first conversion module (3).

2. Charging device (2) according to claim 1, which is also adapted for:
being supplied by the battery (5) with direct current having the second voltage, and converting, in the second conversion module (4), this direct current having the second voltage into direct current having the first voltage, converting, in the first conversion module (3), this direct current having the first voltage into output alternating current, and supplying the alternating current source (1) with this output alternating current.

3. Charging device (2) according to claim 1, wherein the second conversion module (4) comprises a first conversion circuit (8) connected to the first conversion module (3), a second conversion circuit (9) adapted for being connected to the battery (5), and a third conversion circuit (10) adapted for being connected to the equipment (7a, 7b, 7c), these three conversion circuits (8, 9, 10) being connected to the single transformer (11), the charging device (2).

4. Charging device (2) according to claim 1, which is adapted for simultaneously supplying the battery (5) with direct current having the second voltage, and the equipment (7a, 7b, 7c) with direct current having the third voltage, the charging device (2).

5. Charging device (2) according to claim 1, wherein:
the input alternating current has a voltage of 80 V to 300 V, and/or a power of 0.5 kW to 35 kW, and/or
the first voltage is equal to 270 V to 440 V; and/or
the second voltage is equal to 20 V to 550 V; and/or
the third voltage is equal to 5 V to 20 V.

6. Charging device (2) according to claim 1, wherein the equipment (7a, 7b, 7c) also comprises one or more items of equipment selected from among sensors, indicator lights, an onboard computer, lighting means and a car radio.

7. Charging device (2) according to claim 1, wherein the motorised appliance (6) is a vehicle.

8. Motorised appliance (6), comprising the charging device (2) according to claim 1, the battery (5) and the equipment (7a, 7b, 7c), the equipment (7a, 7b, 7c), apart from the secondary battery (7a).

9. Motorised appliance (6) according to claim 8, which is a vehicle.

10. Method for charging a battery (5) and supplying equipment (7a, 7b, 7c) of a motorised appliance (6), said equipment (7a, 7b, 7c) comprising a secondary battery (7a), the method comprising:
according to a first operating mode, providing an input alternating current, converting the input alternating current into direct current having a first voltage, and:
converting the direct current having the first voltage into direct current having a second voltage, and supplying the battery (5) with the direct current having the second voltage; and/or
converting the direct current having the first voltage into direct current having the third voltage, and supplying the equipment (7a, 7b, 7c) with the direct current having the third voltage;
according to a second operating mode, providing direct current having the second voltage by the battery (5), converting the direct current having the second voltage into direct current having a third voltage, and supplying the equipment (7a, 7b, 7c) with the direct current having the third voltage;
according to a third operating mode, providing direct current having the third voltage by the secondary battery (7a), converting the direct current having the third voltage into direct current having the first voltage, and converting the direct current having the first voltage into alternating current;
the first operating mode, the second operating mode and the third operating mode being implemented separately in time;
wherein each conversion of a direct current into another direct current having a different voltage comprises a step of transforming into an intermediate alternating current by means of the same single transformer (11).

11. Charging and supply method according to claim 10, also comprising:
according to a fourth operating mode, providing direct current having the second voltage by the battery (5), converting the direct current having the second voltage into direct current having the first voltage, and converting the direct current having the first voltage into output alternating current, and providing the output alternating current to an external electrical network.

12. Charging and supply method according to claim 10, wherein,
in the first operating mode, supplying the battery (5) with direct current having the second voltage and supplying the equipment (7a, 7b, 7c) with direct current having the third voltage are at least partially simultaneous, the method preferably comprising regulating the third voltage independently of the second voltage.

13. Charging and supply method according to claim 10, wherein:
the input alternating current has a voltage of 80 V to 300 V, and/or a power of 0.5 kW to 35 kW; and/or
the first voltage is equal to 270 V to 440 V; and/or
the second voltage is equal to 20 V to 550 V; and/or
the third voltage is equal to 5 V to 20 V, for example approximately 12 V.

14. Charging and supply method according to claim 10, wherein the equipment (7a, 7b, 7c) comprises, apart from the secondary battery (7a), one or more items of equipment selected from sensors, indicator lights, an onboard computer, lighting means and a car radio.

15. Charging and supply method according to claim 10, wherein the motorised appliance (6) is a vehicle.
